(19) United States
(12) Patent Application Publication
(10) Pub. No.: US 2026/0028209 A1
(43) Pub. Date: Jan. 29, 2026

(54) HYDRAULIC CAR JACK

(71) Applicant: EWO Fluid Power GmbH, Owen (DE)

(72) Inventors: Christian EVESQUE, Ohmden (DE); Ferdinand EVESQUE, Schlierbach (DE)

(73) Assignee: EWO Fluid Power GmbH, Owen (DE)

(21) Appl. No.: 19/179,101

(22) Filed: Apr. 15, 2025

(30) Foreign Application Priority Data
Apr. 15, 2024 (DE) 10 2024 110 558.5

(51) Int. Cl. B66F 3/24; B66F 3/26

(52) U.S. Cl. CPC B66F 3/245; B66F 3/26

(57) ABSTRACT

The invention relates to a hydraulically actuated vehicle jack (1), including a lifting support (3) which can be pivoted about a horizontal axis (2) and moved from a lower starting position (A) into an upwardly pivoted lifting position (H), a support plate (5) arranged on the lifting support (3) for supporting a part of a vehicle to be lifted, a hydraulic cylinder (4), the actuation of which causes a pivoting movement of the lifting support (3), a pump unit (6) for actuating the hydraulic cylinder (4), at least one rolling element (9) for rolling the vehicle jack (1) to a desired work site for lifting a vehicle, and a rigid base structure (10) which rests on the ground (U) at the work site when a vehicle is being lifted and prevents lateral movement of the vehicle jack (1).

The present invention relates to a hydraulically operated car jack according to the preamble of claim 1. This jack comprises a lifting support which can be pivoted about a horizontal axis and which can be moved from a lower starting position into an upwardly pivoted lifting position in order to lift a vehicle, and a support region arranged on the lifting support, in particular a support plate for supporting a part of a vehicle to be lifted, such as the body, the chassis or the frame structure of the vehicle. Furthermore, the jack comprises a hydraulic cylinder with a cylinder housing and a piston displaceably received therein and connected to a piston rod, wherein the hydraulic cylinder or the piston rod is operatively connected to the lifting support in such a way that actuation of the hydraulic cylinder, i.e. a displacement of the piston and thus of the piston rod relative to the cylinder housing, causes a pivoting movement of the lifting support. In addition, the jack comprises a pump unit hydraulically connected to the hydraulic cylinder for actuating the hydraulic cylinder, as well as at least one rolling element, for example a pair of rollers or a roller, over which the jack can be driven or rolled to a desired working location for lifting a vehicle.

Such hydraulically operated jacks are commonly used for the controlled lifting and lowering of vehicles, such as cars or motor homes. They are used in both private and commercial settings, particularly when changing vehicle wheels. Particularly widespread is the trolley jack design, which is characterized by increased maneuverability thanks to several rolling elements, some of which can also pivot around a vertical axis. For maneuvering, trolley jacks typically feature an elongated operating lever which, in addition to its function as a steering lever, can also serve as a pump lever for actuating a hydraulic cylinder and a connected jack support. Such a hydraulic trolley jack is known, for example, from DE 10 2019 121 343 B3.

DE 20 2007 002 358 U1 discloses a hydraulically operated trolley jack in which the operating lever can also be pivoted to one side around a vertical pivot axis to enable use even in confined spaces.

DE 20 2009 018 187 U1 discloses a hydraulic trolley jack with a double-piston pump.

Since the support plate or support area located at the free end of the jack support moves in a circular arc when the jack support is pivoted upwards, the entire trolley jack performs a lateral compensating movement during the jack support's lifting movement, during which the trolley jack rolls to one side in its longitudinal direction via its rolling elements. This lateral forward or backward movement of the jack can compromise safety when lifting a vehicle.

DE 198 39 835 A1 discloses a lifting device for vehicles that does not have a rolling element for rolling the device, but instead has a rigid base structure that rests on the ground when a vehicle is lifted. Moving the lifting device to another location therefore involves significant effort.

EP 0 336 927 A1 discloses a mobile lifting platform for lifting motor vehicles. It has rollers at one end of a base frame, over which it can be rolled to a desired working location. The other end of the base frame rests on the ground when a vehicle is lifted.

The objective of the present invention is to create a structurally simple, hydraulically operated jack of the type mentioned above, which is easy to handle despite its compact design and offers increased safety.

This objective is achieved according to the invention by a hydraulically operated jack according to claim 1. Advantageous embodiments and practical further developments of the invention are described in the dependent claims.

The solution according to the invention provides that the hydraulic cylinder is rigidly and immovably connected to the floor structure of the jack by its cylinder housing. The cylinder housing is fixed and positionally stable, i.e., it is not rotatable or pivotable, and is also not translationally displaceable, attached to the floor structure. This achieves a particularly simple design that requires no means for a movable or pivotable mounting of the hydraulic cylinder.

Since the jack has a rigid base structure that rests on the ground when raising and lowering a vehicle at the work site, lateral movement of the jack relative to the ground in all directions is reliably prevented during the lifting movement. The rigid base structure of the jack remains immobile on the ground throughout the entire lifting process. This represents a significant advantage, as the elimination of lateral compensating movement of the jack offers significantly greater safety when lifting a vehicle.

The jack according to the invention is simple in design, inexpensive to manufacture, and easy to handle. Furthermore, it features a very compact construction, with a particularly low height in the lower starting position, allowing the jack to be used even on very low-slung vehicles. Nevertheless, the jack can also achieve great lifting heights.

It is particularly advantageous if the jack has a support area which is located at an end region of the jack that is remote from or facing away from the support plate and which can be displaced on or at the floor structure along a guide track, wherein the jack has at least one connecting strut which is pivotally connected, on the one hand, to a first pivot point located on the floor structure and directly or indirectly firmly connected thereto, and, on the other hand, to a second pivot point which is located between the support plate and the support area in a central region on the jack and is directly or indirectly firmly connected thereto. Advantageously, there is a horizontal axis in the support area of the jack, about which the jack can be pivoted up and down.

In this case, the first articulation point of the connecting strut can advantageously be arranged on a hinge element that is integral with the cylinder housing or on a hinge element that is permanently connected to the cylinder housing.

For the purposes of the present patent application, the hinge connection of a first element to a second element means that the two elements are hingedly connected to one another, whereby the hinge connection can be implemented directly or indirectly via interposed elements.

It is also particularly advantageous if the at least one rolling element is arranged and mounted on the support area of the lifting support and if, in the lower starting position of the lifting support, it projects laterally beyond the ground structure in the direction of the guide track. In this way, the at least one rolling element can be brought into contact with the ground when the jack is lifted at the end area opposite the rolling element, preferably using a handle provided for this purpose. In this way, the jack, which has been lifted on one side, can be easily moved and rolled to a desired work location for lifting a vehicle. As soon as the jack is put down at the work location again, the at least one rolling element loses its contact with the ground, so that the jack rests immovably on the ground via its rigid base structure.

It is particularly advantageous if the at least one rolling element rolls on the upper side of the floor structure when the jack is pivoted up into a lifting position, whereby the upper side of the floor structure thus forms a straight guide track for the support area of the jack. In this way, the at least one rolling element can perform two functions at once: on the one hand, it enables the jack to roll to a desired work location before lifting a vehicle, and on the other hand, when the jack is in operation and lifting a vehicle, it guides the support area of the jack along the guide track formed by the upper side of the floor structure. During the lifting process, the support forces exerted by the lifted vehicle on the jack are transferred to the ground via the floor structure. Lateral transverse forces acting laterally during the lifting process can also be absorbed by the guide track.

It is particularly advantageous if the longitudinal direction of the hydraulic cylinder, which is defined by the longitudinal direction of the piston rod of the hydraulic cylinder, is aligned along the linear guideway for the support area of the jack support or parallel to this guideway. The hydraulic cylinder preferably extends parallel to the top side of the floor structure so that the piston rod can be extended and retracted parallel to the top side of the floor structure. The hydraulic cylinder is thus arranged horizontally and remains unchanged in this horizontal orientation even during the lifting process.

According to a particularly preferred embodiment of the invention, it is provided that the hydraulic cylinder is designed to be double-acting and the free end of the piston rod is articulated on the support region of the lifting support, preferably on the axis of the at least one rolling element.

The lifting support can advantageously be raised from the lower starting position into an upwardly pivoted lifting position by retracting the piston rod into the cylinder housing and can be lowered from an upwardly pivoted lifting position into the lower starting position by extending the piston rod from the cylinder housing.

It is particularly advantageous if at least one check valve or safety valve is integrated into the hydraulic cylinder or into a connected valve block, which prevents the piston rod from accidentally extending from the hydraulic cylinder. This prevents the jack from accidentally lowering from an upwardly pivoted lifting position to the lower starting position.

According to a particularly preferred embodiment of the invention, a locking element is arranged on the support area of the lifting support, preferably in the region of the axis of the at least one rolling element. This locking element can interact positively with locking catches or with a rack structure formed on the floor structure. This provides additional mechanical security against unintentional lowering of the lifting support.

It is particularly advantageous if the locking element is pressed against the locking detents or the rack structure under spring load, and if it can be disengaged from the locking detents or the rack structure by a release element, preferably a Bowden cable or an electromagnetic actuator, thus allowing the jack to pivot downwards into its initial position. The locking element can preferably be formed by a spring-loaded pawl.

According to another particularly preferred embodiment of the invention, the lifting support is formed by two lifting arms located on either side of the hydraulic cylinder, which are rigidly connected to each other, i.e., cannot be moved relative to each other, and thus can only be moved together. The hydraulic cylinder is thus located between the two lifting arms.

It is particularly advantageous if the jack also has two connecting struts located on both sides next to the hydraulic cylinder, which are each pivotably connected on the one hand to a first pivot point located on the floor structure and directly or indirectly firmly connected thereto, and on the other hand to a second pivot point located on one of the two lifting arms and directly or indirectly firmly connected thereto.

A particularly compact design of the jack can be achieved by forming the base structure with a plate that forms a common or separate guideway on its upper side for each rolling element.

According to a particularly preferred embodiment of the invention, the car jack comprises a parallel arm or two parallel arms each assigned to a lifting arm, which is or are articulated on the one hand in the region of its free end to the piston rod and on the other hand to the support plate in such a way that the parallel arm or the parallel arms together with the lifting support or with the two lifting arms forming the lifting support form or form a parallelogram arrangement in a manner known per se and thus hold or hold the support plate parallel to the ground structure, preferably horizontally aligned, at any lifting height.

According to another particularly preferred embodiment of the invention, the jack comprises an electric motor, which can drive the pump unit for actuating the hydraulic cylinder. The jack advantageously has a control unit electrically connected to the electric motor, which can be used to control the electric motor for actuating the jack. The control unit, in turn, can advantageously be connected to a control panel comprising operating elements such as switches, via which the jack can be manually operated.

Advantageously, at least one preferably replaceable battery can be arranged on the jack to supply energy to the electric motor.

It is also particularly advantageous if the pump unit is a reversing unit driven by an electric motor. This eliminates the need for directional control valves to control the hydraulic cylinder. It is particularly advantageous if the reversing unit is located directly next to the hydraulic cylinder and is connected directly to the hydraulic cylinder or to a valve block connected to the hydraulic cylinder without any hoses or pipes. This eliminates the need for additional hydraulic lines, which pose the risk of damage or leaks, and results in a particularly compact, simple, and safe design.

It is particularly advantageous if the control unit is connected to a receiver via which the jack can be operated remotely using a control unit, either wired or wirelessly.

The present invention further relates to an arrangement of two or more jacks of the latter type, in which the control units of the individual jacks are connected to each other via cable or wirelessly, in particular via radio or WLAN. The control units of the jacks can thus communicate with each other.

In such an arrangement of at least two jacks, it is particularly advantageous if the control unit of one of the jacks, which functions as the master jack, is connected to a receiver via which all jacks can be remotely controlled either wired or wirelessly using a control unit. The other jacks function as slave jacks. According to a particularly preferred embodiment of this arrangement of at least two jacks, the control unit of the master jack is connected to at least one inclination sensor that can be detachably attached to a vehicle to be lifted. All jacks connected to one another for control purposes are controlled via the control unit of the master jack based on the data available from the at least one inclination sensor to achieve a desired alignment or leveling of the vehicle. The at least one inclination sensor provides data on the current inclination of the vehicle to the control unit of the master jack, which then determines corresponding data for controlling the other jacks in order to achieve a desired alignment or leveling of the vehicle. In an arrangement of three or four jacks, the control unit of the master jack can advantageously be connected to two inclination sensors, which can be removably attached to a vehicle to be lifted at an angle of preferably 90° to one another. A method that can be advantageously used in this case is described, for example, in patent DE 10 2019 002 237 B4.

Further advantages and features of the invention will become apparent from the following description and the embodiment shown in the drawings.

It shows:

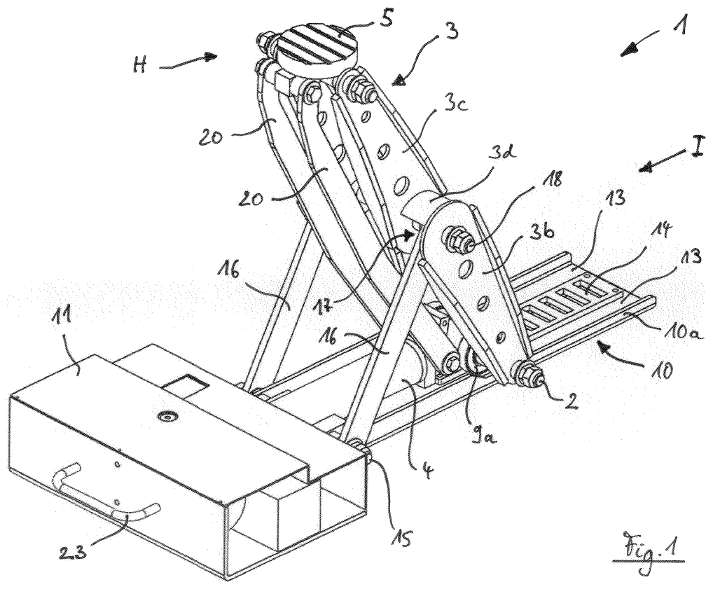

FIG. 1: a perspective view of a car jack according to the invention from a first direction,

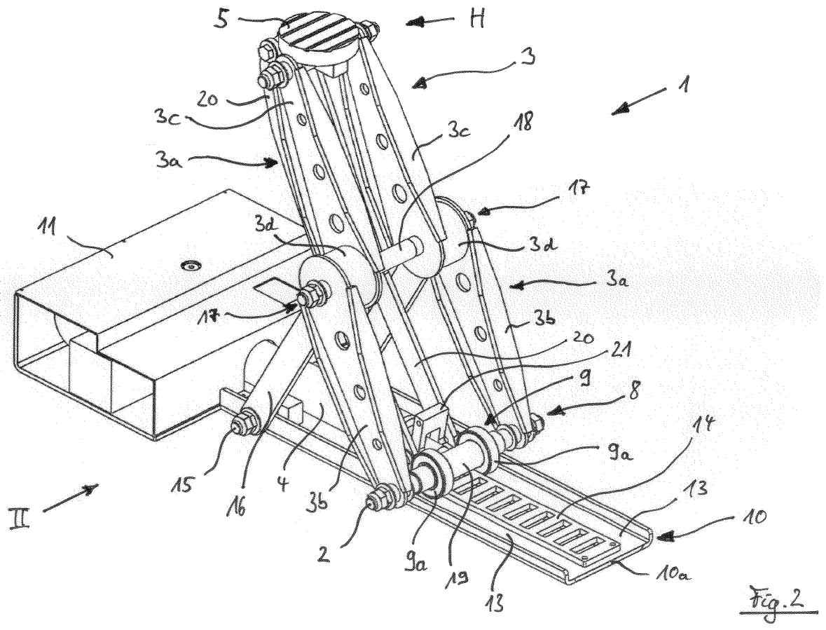

FIG. 2: a perspective view of the jack from FIG. 1 from a second direction,

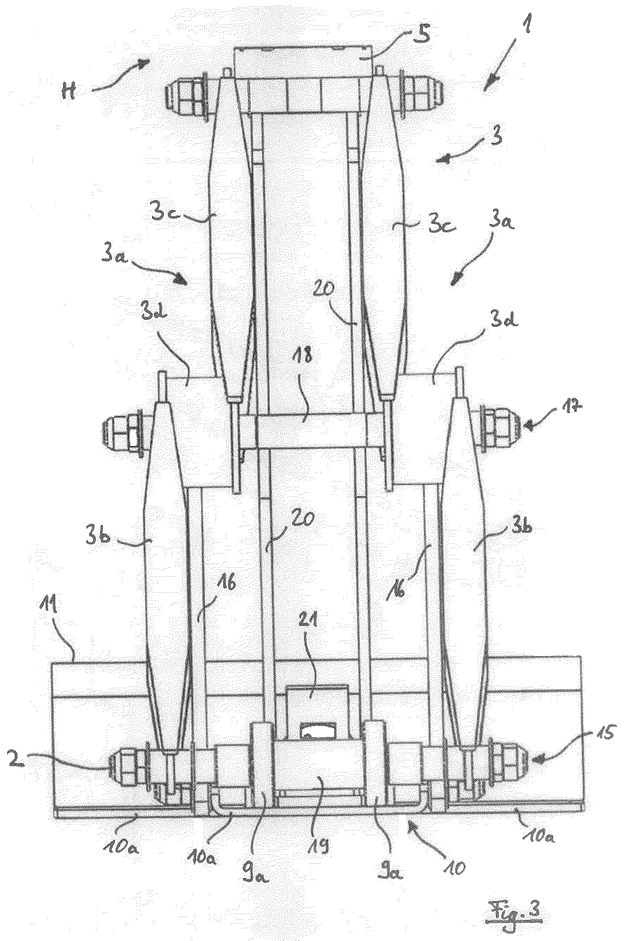

FIG. 3: a side view of the jack from FIG. 1 from direction I in FIG. 1,

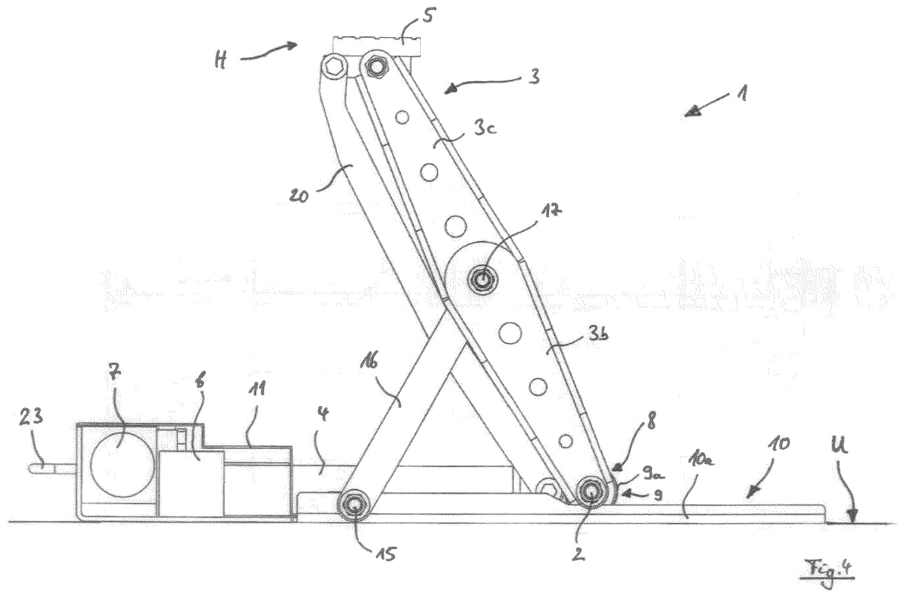

FIG. 4: a side view of the jack from FIG. 1 from direction II in FIG. 2,

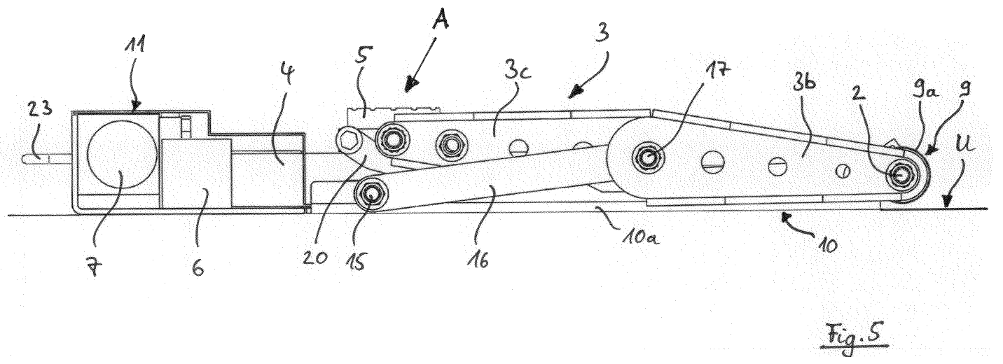

FIG. 5: a side view of the jack from FIG. 4 in the lower starting position,

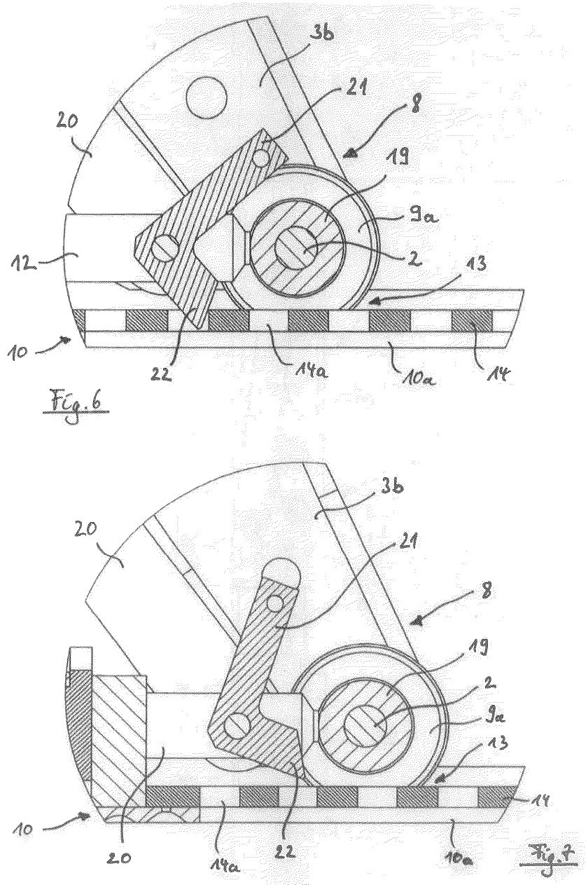

FIG. 6: an enlarged sectional view of the locking element in the locking position, and

FIG. 7: the locking element from FIG. 6 in the release position.

The hydraulically operated jack 1 shown in the figures is used for the selective raising and controlled lowering of a section of a vehicle, such as a passenger car or mobile home. Depending on its size, it can also be used for larger vehicles such as buses or trucks.

The vehicle jack 1 comprises a lifting support 3 which can be pivoted about a horizontal axis 2 and which can be pivoted upwards from a lower starting position A (FIG. 5) into an upper lifting position H (FIGS. 1 to 4) by means of a hydraulic cylinder 4. A support plate 5 is pivoted at the upper end of the lifting support 3 in the lifting position H. This support plate forms the contact point for the part of the vehicle to be lifted, which can be formed, for example, by part of the chassis or part of the frame structure of the vehicle. To actuate the hydraulic cylinder 4 and thus also to actuate the lifting support 3 operatively connected thereto, a pump unit 6 is provided on the vehicle jack 1 which is hydraulically connected to the hydraulic cylinder 4. In the exemplary embodiment shown here, this pump unit is formed by a reversing unit which is driven by an electric motor 7 connected to a control unit (not shown in detail here). Depending on the direction of rotation of the electric motor 7, the lifting support 3 can be raised to the lifting position H or lowered to the starting position A. As an alternative to a reversible hydraulic unit, a non-reversible hydraulic unit can also be used, which is connected to corresponding control valves, which can then also be actuated by the control unit.

In the illustrated embodiment, the lifting support 3 consists of two lifting arms 3a, which are arranged on either side of the hydraulic cylinder 4 and each comprise a lower partial arm 3b and an upper partial arm 3c. The two approximately equally long partial arms 3b and 3c are arranged laterally offset from one another and are connected to one another in a rotationally fixed manner via a connecting element 3d with an approximately semicircular cross-section.

At the lower end of the jack support 3 in the lifting position H, which is opposite the support plate 5, a support area 8 forms. A rolling element 9, formed here by two rollers 9a, is mounted in this support area 8. The two rollers 9a, or the rolling element 9 formed by them, is mounted on the axle 2, which firmly connects the two lifting arms 3a and simultaneously forms the horizontal axis 2 about which the jack support 3 can be pivoted.

According to the invention, the jack 1 comprises a rigid base structure 10, which here is formed by an elongated base plate 10a. When the jack 1 is in use, i.e., when lifting and lowering a vehicle, this base structure 10 rests flat on the ground U at the work site, so that lateral movements of the jack 1 relative to the ground in all directions are reliably excluded due to the frictional forces acting between the base structure 10 and the ground U during use. By providing a suitably roughened surface structure on the underside of the base structure 10, the frictional forces preventing lateral movement of the jack 1 and thus the operational reliability of the jack 1 can be further increased. The base structure 10 of the jack 1 remains immobile on the ground U throughout the entire lifting process.

On the upper side of the base plate 10a forming the rigid floor structure 10, there is a housing 11, which houses, among other components, the pump unit 6 and the electric motor 7, as well as a control unit controlling the electric motor 7 and a replaceable battery for supplying power to the electric motor 7 and the control unit. The entire jack 1 thus forms a self-contained unit that can be operated by a motor without additional power connections such as hydraulic, pneumatic, or electrical lines.

Furthermore, the double-acting hydraulic cylinder 4, here designed as a double-acting cylinder, is rigidly and immovably mounted with its cylinder housing on the top side of the base plate 10a. The bottom of the cylinder housing opposite the piston rod 12, which contains the two pressure ports of the hydraulic cylinder 4 and a safety valve, extends into the housing 11. In the housing 11, the bottom of the hydraulic cylinder 4 is located directly next to the reversing unit forming the pump unit 6, where the latter is connected directly to the pressure ports of the hydraulic cylinder 4 or to a valve block of the hydraulic cylinder 4 without any intervening hoses or pipes.

At the end of the base plate 10a facing away from the housing 11, two guide tracks 13 are formed on the top side, in and on each of which a roller 9a of the rolling element 9 can roll. The two guide tracks 13 are separated from each other by a ladder-shaped rack structure 14 located between them. During rolling, the two rollers 9a of the rolling element 9 are guided in and on the two guideways 13. At the same time, the rollers 9a also support the support area 8 of the lifting support 3, so that the weight forces acting when lifting a vehicle are absorbed by the ground U via the rollers 9a of the rolling element 9 and the ground structure 10. The two lifting arms 3a are firmly connected to one another by the axle 2, which is arranged in the section of the lower partial arms 3b forming the support area 8.

In addition, on the upper side of the base plate 10a, on both sides of the hydraulic cylinder 4, there is a fixed first pivot point 15 for each connecting strut 16. Two connecting struts 16 are provided, each pivoted at one end to one of the two first pivot points 15 and at the other end via a second pivot point 17 to an approximately central area of the two lifting arms 3a. The two second pivot points 17 are located on an axis 18, via which the two lifting arms 3a are also connected to each other. The axis 18 is surrounded on each side by one of the two connecting elements 3d, which connect the two partial arms 3b and 3c of the two lifting arms 3a.

The piston rod 12 of the hydraulic cylinder 4 extends parallel to the two guideways 13. The free end of the piston rod 12 is articulated to the axis 2 by means of a bearing bush 19 formed thereon, on which the two rollers 9a are also mounted. When the piston rod 12 is in its maximum extended position, the lifting support 3 is in the lower starting position A (FIG. 5). As the piston rod 12 is increasingly retracted into the housing of the hydraulic cylinder 4, which is immovably connected to the floor structure 10, the support area 8 of the lifting support 3 increasingly approaches the housing of the hydraulic cylinder 4 as the rollers 9a roll on the guideways 13. Due to the leverage of the two connecting struts 16, the lifting support 3 is increasingly erected towards the upper lifting position H. The support plate 5 thereby performs an at least almost exactly vertical lifting movement.

Since an additional parallel arm 20 is arranged parallel to each of the two lifting arms 3a, the support plate 5 always remains in its horizontal orientation throughout the entire lifting movement. The parallel arms 20 are articulated on the piston rod 12 at a distance from the axis 2 in the area of the free end of the piston rod 12, and on the other hand, they are articulated on the support plate 5 at an equal distance from the bearing of the support plate 5 on the lifting support 3. Thus, the two parallel arms 20, together with the two lifting arms 3a, each form a parallelogram arrangement that keeps the support plate 5 aligned parallel to the base plate 10a at every lifting height.

As an additional safety device against unintentional lowering of the lifting support 3, a pivotably mounted locking element 21 is arranged at the free end of the piston rod 12. In the illustrated embodiment, it is designed as a pawl with a locking lug 22, which is pressed into the gaps 14a of the rack structure 14 by a spring element (not shown in detail), such as a leg spring, in a form-fitting manner, in order to block any unintentional movement of the support area 8 away from the housing of the hydraulic cylinder and thus any unintentional lowering of the lifting support 3. Alternatively, the locking element 21 can also be arranged on the support area 8 of the lifting support 3.

However, to enable a desired lowering of the lifting support 3, a release element (not shown here) is also provided, by means of which the locking lug 22 can be pivoted out of the gaps of the rack structure 14 against the spring load, thus enabling unblocked movement of the support area 8 in the direction causing a lowering of the lifting support 3. The release element can, for example, be formed mechanically by a Bowden cable guided from the housing 11 via the axis 18 or preferably by an electromagnetic actuator.

As long as the jack support 3 is in the lower starting position A (FIG. 5), the two rollers 9a protrude beyond the end of the base plate 10a, where they can rotate freely. In this way, the rollers 9a can be brought into contact with the ground U by lifting the opposite side of the jack 1, which can preferably be done via a handle 23 arranged on the base plate 10a or on the housing 11, so that the jack, raised on one side, can be easily moved and rolled to a desired work location for lifting a vehicle.

1. Hydraulically operated jack (1), comprising
a lifting support (3) pivotable about a horizontal axis (2) and movable from a lower starting position (A) into an upwardly pivoted lifting position (H),
a support plate (5) arranged on the lifting support (3) for supporting a part of a vehicle to be lifted,
a hydraulic cylinder (4), the actuation of which causes a pivoting movement of the lifting support (3),
a pump unit (6) for actuating the hydraulic cylinder (4),
at least one rolling element (9) for rolling the jack (1) to a desired working location for lifting a vehicle,
a rigid floor structure (10) which rests on the ground (U) when lifting a vehicle at the work site and prevents lateral movement of the jack (1),
characterized by,
that the cylinder housing of the hydraulic cylinder (4) is rigidly and immovably connected to the base structure (10) of the jack (1).

2. Car jack (1) according to claim 1, characterized in that the lifting support (3) has a support region (8) facing away from the support plate (5) which can be displaced on or at the floor structure (10) along a guide track (13), wherein the car jack has at least one connecting strut (16) which is pivotally articulated on the one hand to a first articulation point (15) located on the floor structure (10) and on the other hand to a second articulation point (17) located between the support plate (5) and the support region (8) on the lifting support (3).

3. Car jack (1) according to claim 2, characterized in that the at least one rolling element (9) is mounted on the support region (8) of the lifting support (3) and, in the lower starting position (A) of the lifting support (3), projects laterally beyond the floor structure (10) in the direction of the guide track (13).

4. Car jack (1) according to claim 2, characterized in that the at least one rolling element (9) is mounted on the support region (8) of the lifting support (3) and rolls on an upper side of the floor structure (10) forming the guide track (13) when the lifting support (3) is pivoted upwards.

5. Car jack (1) according to claim 4, characterized in that the guide track (13) for the support area (8) of the lifting support (3) is designed to be rectilinear and the piston rod (12) of the hydraulic cylinder (4) is aligned along the guide track (13) or parallel thereto.

6. Car jack (1) according to claim 5, characterized in that the hydraulic cylinder (4) is double-acting and that the free end of the piston rod (12) is articulated on the support region (8) of the lifting support (3), namely on the axis (2) of the at least one rolling element (9), on the lifting support (3).

7. Car jack (1) according to claim 6, characterized in that the lifting support (3) can be moved from the lower starting position (A) into an upwardly pivoted lifting position (H) by retracting the piston rod (12) into the cylinder housing, and in that the lifting support (3) can be moved from an upwardly pivoted lifting position (H) into the lower starting position (A) by extending the piston rod (12) from the cylinder housing.

8. Car jack (1) according to claim 7, characterized in that at least one check valve or safety valve is integrated into the hydraulic cylinder (4) or into a valve block connected to the hydraulic cylinder (4), which prevents an unintentional extension of the piston rod (12) from the hydraulic cylinder (4).

9. Car jack (1) according to claim 5, characterized in that on the support area (8) of the lifting support (3), preferably in the area of the axis (2) of the at least one rolling element (9), a locking element (21) is arranged on the lifting support (3), which can cooperate in a form-fitting manner with locking catches (14a) provided on the floor structure (10).

10. Car jack (1) according to claim 1, characterized in that it comprises an electric motor (7) by which the pump unit (6) can be driven, and in that it comprises a control unit connected to the electric motor (7) by which the electric motor (7) can be controlled to actuate the car jack (1).

11. Car jack (1) according to claim 10, characterized in that the pump unit (6) is formed by a reversing unit, wherein the reversing unit is arranged directly next to the hydraulic cylinder (4) and is connected without wires directly to the hydraulic cylinder (4) or to a valve block of the hydraulic cylinder (4).

12. Car jack (1) according to claim 10, characterized in that the control unit is connected to a receiver via which the car jack (1) can be remotely operated by means of a control unit in a wired or wireless manner.

13. Arrangement of at least two car jacks (1) according to claim 10, characterized in that the control units of the car jacks (1) are connected to one another via a cable or wirelessly via radio or WLAN.

14. Arrangement of at least two car jacks (1) according to claim 13, characterized in that the control unit of one of the car jacks (1), which functions as a master car jack, is connected to a receiver via which all car jacks (1) can be remotely operated by wired or wireless means by means of an operating unit.

15. An arrangement of at least two jacks (1) according to claim 14, characterized in that the control unit of the master jack is connected to at least one inclination sensor that can be detachably attached to a vehicle to be lifted, wherein all jacks (1) can be controlled via the control unit of the master jack based on the data available from the at least one inclination sensor to achieve a desired alignment or leveling of the vehicle.
